(19) United States
(12) Patent Application Publication
(10) Pub. No.: US 2021/0125433 A1
(43) Pub. Date: Apr. 29, 2021

(54) SAFETY SYSTEM FOR COUPLING TRUCK AND TRAILER

(71) Applicant: Brandon Gonzalez, Joliet, IL (US)

(72) Inventor: Brandon Gonzalez, Joliet, IL (US)

(21) Appl. No.: 17/061,706

(22) Filed: Oct. 2, 2020

Related U.S. Application Data
(60) Provisional application No. 62/925,009, filed on Oct. 23, 2019.

(51) Int. Cl. G07C 5/08; B62D 53/08; B60Q 1/00; B60S 1/66

(52) U.S. Cl. CPC G07C 5/0825; B60S 1/66; B60Q 1/0005; B62D 53/08

(57) ABSTRACT

A coupling system for ensuring successful engagement of a transportation vehicle and a trailer. The coupling system includes an indicator bar with an integral illuminator, wherein successful coupling of the vehicle and trailer is indicated by the illuminated indicator bar being readily observable during visual inspection of the coupling area.

### CROSS-REFERENCE TO RELATED APPLICATION

Priority is claimed to U.S. Provisional Application No. 62/925,009, entitled “Safety System for Coupling Truck and Trailer,” filed Oct. 23, 2019, which is incorporated herein by reference in its entirety.

### FIELD OF TECHNOLOGY

The following disclosure relates to vehicle transportation, and more particularly, to utilizing a safety system or device to ensure proper coupling of a trailer to a vehicle.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

One method of transporting goods and/or materials includes loading them in or onto a trailer, which may be attached to a road-transportation vehicle, such as a semi-truck, and/or placed in or onto a railcar. Attaching the trailer is often times accomplished by coupling a post, e.g., kingpin, which extends from the trailer, to a plate, i.e., fifth wheel, of the truck or railcar. A coupling mechanism of the fifth wheel, e.g., collar, receives and locks the kingpin in place. Position sensors can be utilized to indicate secured coupling and/or de-coupling of the truck and trailer. To ensure transportation safety, lighting equipment may be utilized to illuminate the coupling area to assist transportation personnel in determining the status of one or more steps within the coupling process, e.g., coupled, de-coupled. For example, where transportation personnel are encouraged or required to visually inspect the coupling area to ensure proper coupling and/or de-coupling of the trailer with the truck, lights may be employed proximate the fifth wheel to illuminate toward the coupling area, e.g., onto the kingpin and/or coupling collar. Such lighting equipment is typically deployed to shine upon the coupling area and is generally exposed to dirt, mud, snow, road debris, etc., which may damage or obscure the lighting components and degrade its illumination ability, and thus make it difficult for transportation personnel to visually inspect the coupling area for safety. Therefore, a clear and unmet need exists to improve the ability for transportation personnel to visually inspect the coupling area to ensure proper coupling of the trailer with the vehicle.

### SUMMARY

Described herein are example embodiments for facilitating safe coupling of a transportation vehicle and a trailer. In general, a means for illuminating is utilized with a means for coupling, e.g., coupler mechanism, of the vehicle. More specifically, the means for coupling may include a fifth wheel of a truck or railcar, e.g., plate, which cooperates with a coupling mechanism to receive a kingpin of the trailer within a channel within the plate. An indicator bar includes an illuminator integral therein, and is responsive to the coupling position of the truck and trailer, whereupon successful coupling of the plate and kingpin, the indicator bar is positioned across the channel and its illuminator is lit. The illumination emitted from the indicator bar projects away from the coupling area, e.g., kingpin, and is readily visible by transportation personnel even though the coupling area is generally dark, which may make it difficult to discern the coupling mechanism, e.g., plate, kingpin, coupling area; due to any accumulated grease, grime, road debris, etc.

Accordingly, an example system, device, or method for facilitating safely coupling a transportation vehicle and a trailer includes a coupling indicator system for a fifth wheel of the vehicle, e.g., truck. The coupling indicator system comprises a plate including a channel for receiving a post, e.g., kingpin of the trailer, proximate a coupling area located near a closed end of the channel, and an indicator bar including an illuminator integral therein, whereupon successful coupling of the kingpin with the plate, the indicator bar is positioned across the channel with its illuminator lit.

Another example system, device, or method for facilitating safely coupling a truck and a trailer is directed to a fifth wheel coupling indicator comprising: a plate including a means for receiving a kingpin of the trailer; a means for coupling the plate to the kingpin; and, an indicator bar including a means, integral therein, for indicating the kingpin coupled to the plate, the indicator bar responsive to the means for coupling the plate to the kingpin, whereupon successful coupling of the kingpin with the plate, the indicator bar positioned across the means for receiving the kingpin and the means for indicating illuminated.

A further example system, device, or method for safely coupling a vehicle and a trailer is directed to a coupling indicator that can be installed to cooperate with the fifth wheel, e.g., coupling mechanism, of the vehicle, e.g., truck, railcar. The coupling indicator includes an indicator bar with an illuminator integrated therein. The indicator bar can be installed proximate the fifth wheel and is movably responsive to the coupling and/or decoupling of the fifth wheel and the kingpin of the trailer, whereupon in an uncoupled state, the indicator bar is positioned not to extend into or across a channel within the plate of the fifth wheel for receiving the kingpin; and in a coupled state, the indicator bar is positioned to extend into and/or across the channel and with its illuminator lit.

### BRIEF DESCRIPTION OF THE DRAWINGS

The figures described below depict various aspects of the system, device, and methods disclosed therein. It should be understood that each figure depicts an embodiment of a particular aspect of the disclosed system, device, and/or methods, and that each of the figures is intended to accord with a possible embodiment thereof. Further, wherever possible, the following description refers to the reference numerals included in the following figures, in which features depicted in multiple figures are designated with consistent reference numerals.

FIGS. 1A and 1B illustrate a transportation vehicle, e.g., truck, and trailer in an uncoupled and coupled configuration, respectively;

FIG. 2 is a top view of a coupling system (illustrated in an uncoupled or de-coupled position or state) for facilitating safely coupling the transportation vehicle to the trailer in accordance with the embodiments described herein;

FIG. 3 is a front view of the coupling system illustrated in FIG. 2 in an uncoupled position or state;

FIG. 4 is a top view of the coupling system illustrated in FIG. 2 in a coupled position or state; and

FIG. 5 is a front view of the coupling system illustrated in FIG. 4 in the coupled position or state.

### DETAILED DESCRIPTION

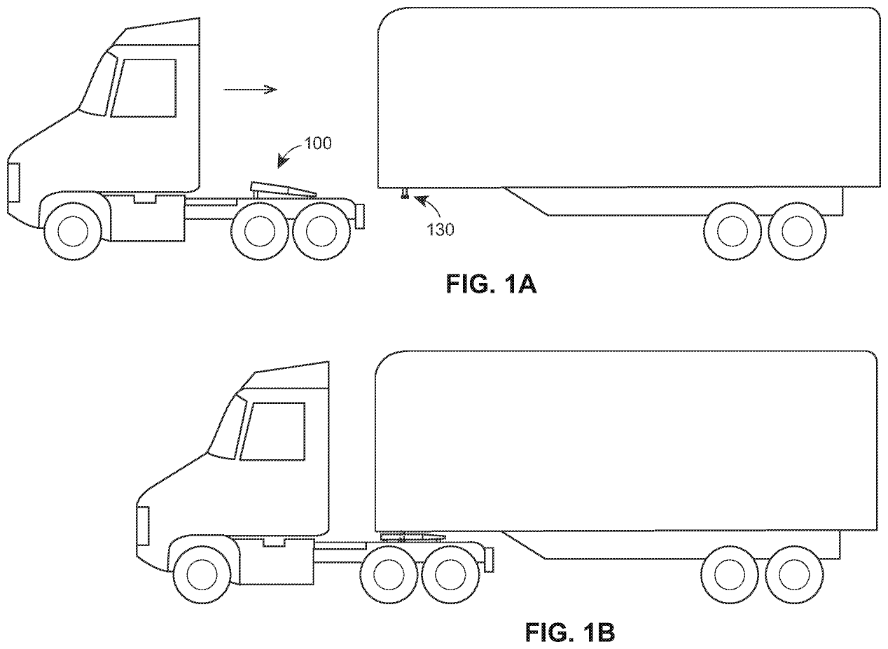

Described herein are example systems, devices, and methods for facilitating the safe coupling of a transportation vehicle, e.g., truck, railcar; and a trailer. The trailer can be open (e.g., flatbed) or closed, or specifically designed for a particular purpose, e.g., towing a boat, motorcycle, snowmobile, recreational vehicle, camper, etc. In general, the truck includes a fifth wheel that receives a vertically orientated post, e.g., kingpin, attached to the trailer. See FIG. 1A. Generally, a coupling area of the fifth wheel includes a U or V-shaped plate with a channel, slot, or throat defined therein for cooperating with the downward-extending kingpin. To couple the truck and trailer, the truck is moved in reverse and the channel of the fifth wheel is aligned with the kingpin. As the fifth wheel of the truck moves toward the trailer, the closed-end, e.g., base, of the channel, slot, or throat of the plate approaches the kingpin, wherein the kingpin is received within the channel of the plate and operatively connected, e.g., coupled, and secured within the fifth wheel. The secured coupling of the fifth wheel and the kingpin allows for pivotal movement therebetween to accommodate turning of the truck-trailer during driving.

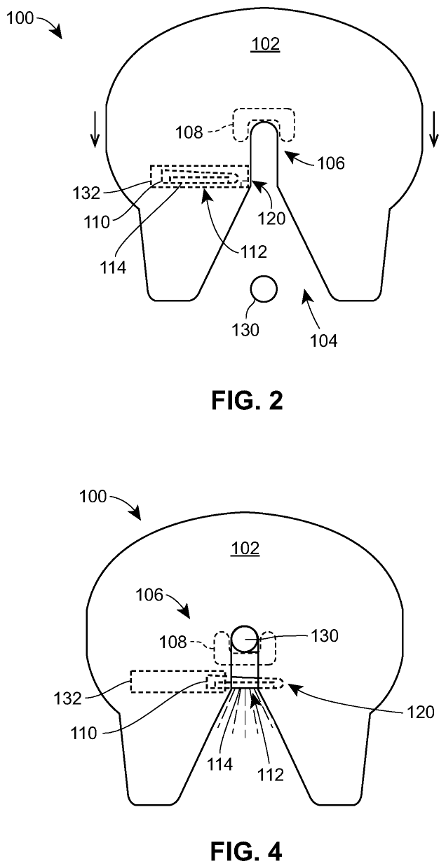

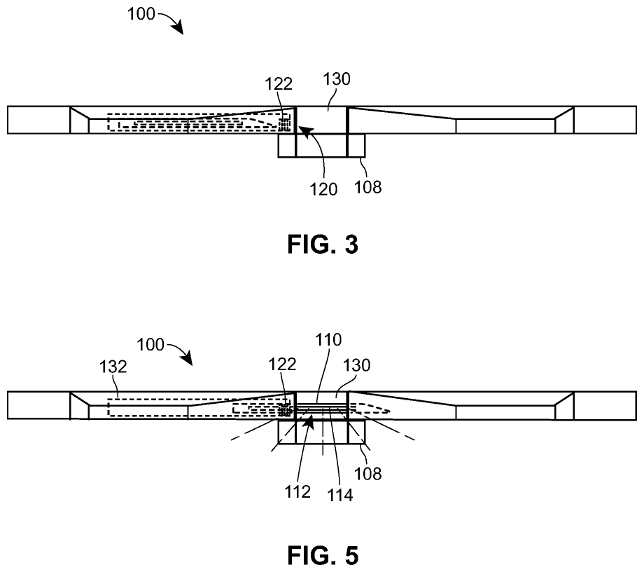

Referring now to FIGS. 2-5, an illustration of a fifth wheel 100 with an example indicator system for facilitating safe coupling of the truck and trailer is illustrated. The fifth wheel 100 includes a plate 102 defining a channel 104, slot, or throat, e.g., U or V-shaped, capable of receiving a kingpin 130. A closed-end of the channel 104 is proximate the center of the plate 102, e.g., coupling area 106. A coupler 108 is proximate the coupling area 106 of the channel 104 to assist in coupling the kingpin 130 with the fifth wheel 100. An indicator bar 110 is positioned proximate the open end of the channel 104 and is movable between an un-coupled or de-coupled position or state (see, for example, FIGS. 2 and 3) and a coupled position or state (see, for example, FIGS. 4 and 5).

The indicator bar 110 include a means for illuminating 112, which is integral within the indicator bar 110. Some example embodiments of the means for illuminating 112 include, and are not limited to, an illuminator 114, for example, a metal filament, a light emitting diode (LED), a light bulb, and the like. The illuminator 114 may be embedded within, or attached (fixedly, removably) to, the indicator bar 110; and may be lit continually or its illumination may be dependent upon, or in response to, the position of the indicator bar 110; for example, with respect to the plate 102 and kingpin 130 being in the coupled or uncoupled position or state. In some embodiments, position sensors, e.g., switches, may be integrated with the fifth wheel 100 to facilitate determination of the coupling process, e.g., among the various stages therein. That is, sensors or switches may be located at one or more ends of the indicator bar's 110 range of travel to determine the position or location of the indicator bar 110, which may also be utilized to activate or deactivate the illuminator 114 with respect to one or more positions within the coupling process, e.g., uncoupled, coupled.

When positioned in the un-coupled position or state (see for example, FIGS. 2 and 3), the indicator bar 110 is generally located near the channel 104, but does not substantively cross or enter the channel 104. In the un-coupled position, the illuminator 114 may be lit, but its illumination is generally not readily observable. For example, the indicating bar 110 and/or its illuminator 114 may be positioned with respect to the fifth wheel 100 and/or coupling area 106 so that its illumination is not readily visible when in the uncoupled position or state to transportation personnel visually inspecting the coupling area; and/or the illuminator 114 may be de-energized when positioned in the un-coupled position or state. In another configuration, while in the un-coupled state, the indicator bar 110 and its integral illuminator 114 may reside within a housing 132, which may effectively contain light emitted from the illuminator 114 when within the housing 132. Alternatively, or in combination with the housing 132, the illuminator 114 may be de-energized when positioned in the un-coupled position or state, wherein the illuminator 114 is not lit when within the housing 132.

When positioned in the coupled position or state (see FIGS. 4 and 5), the indicator bar 110 is generally located substantially within, into, or across the channel 104. When the housing 132 is utilized, the indicator bar 110 and illuminator 114 travel or extend into, within, or across the channel 104. In the coupled position or state, the illuminator 114 is lit and readily observable by inspecting transportation personnel, e.g., truck driver, while visually inspecting the coupling area of the fifth wheel 100. In some embodiments, the illuminator 114 may be energized (e.g., from a non-energized state) when positioned in the coupled position or state. Further, the visible light emitted from the illuminator 114 may be constant, intermittent (e.g., flashing), and/or include one or more colors, patterns, text, etc., any combination of which may be associated with one or more stages of the coupling process. Additionally, and/or alternatively, the illumination emitted from the illuminator 114 may be directed toward the ground and/or another surface, which may be more convenient for transportation personnel to observe and confirm the safe coupling of the truck and trailer.

To facilitate the mechanical coupling of the fifth wheel 100 with the kingpin 130, a lubricant, e.g., grease, may often times be used to lubricate the cooperating surfaces of the respective truck and trailer that contact each other and/or other parts during the coupling and de-coupling processes. Devices, equipment, and/or parts located near the coupling area are susceptible to being contacted by such lubricants, as well from dirt and road debris that may attach to the lubricated parts. In particular, safety devices and/or features located near the coupling area may be adversely affected by unintended and undesired adherence of the lubricants and/or debris. For example, some safety-related coupling devices utilize a light positioned across from the coupling area to illuminate onto the coupling area for visual inspection thereof. However, the exposed light source may be substantially covered by the lubricant and/or dirt and/or debris, and as a result, ineffectively illuminate the coupling area for visual inspection to ensure safe coupling of the truck and trailer. Additionally, or alternatively, the lubricated and/or debris-covered parts involved in the coupling process may be difficult to visually discern to effectively determine the coupling status of the truck-trailer even when the coupling area is illuminated.

When the indicator bar 110 and integrated illuminator 114 of the present invention is positioned with respect to the fifth wheel so as not to be exposed to the environmental elements and/or road debris, the integral illuminator 114 of the indicator bar 110 is more likely to retain sufficient illuminating capability, which can be readily observed by transportation personnel when in the coupling position or state. Additionally, when the indicator bar 110 and the integrated illuminator 114 of the present invention is positioned within the housing 132 (i.e., while in the uncoupled state), the housing 132 substantially covers the indicator bar 110 and prevents lubricants/debris from contacting the indicator bar 110 and the integral illuminator 114. In addition, a means for cleaning 120 the indicator bar 110 and/or the illuminator 114 may implemented and positioned near the indicator bar 110, for example, proximate and/or within the housing 132. The means for cleaning 120 may include a cleaning implement, such as a cloth and/or brush, e.g., bristles 122, and the like; positioned to contact the illuminator 114 during movement or non-movement of the indicator bar 110. For example, when the indicator bar 110 is moved into the channel or out of the channel, the indicator bar 110 and/or the illuminator 114 may contact the bristles 122, which effectively cleans off the illuminator 114.

It is to be understood that the illuminator 114 may be integrated, e.g., retrofit, into a locking bar of many embodiments of the fifth wheel that utilizes the locking bar in its coupling process. For such fifth wheels, the locking bar slides across and/or into the channel to further secure the coupled kingpin within the receiving slot of the plate of the fifth wheel. The locking bar may be modified by integrating the illuminator 114 therein, or the locking bar may be replaced with another locking bar with an integrated illuminator 114. Similarly, the indicator bar 110 and integrated illuminator 114 described herein may be operatively attached to an existing fifth wheel to provide the safety-related inspection aspects described herein.

The integrated illuminator within the indicator bar of the present invention provides transportation personnel with an enhanced inspection capability over existing coupling systems having illuminating mechanisms that are more susceptible to the adverse effects of the operating environment, e.g., dirt, lubricant, road debris. In particular, when in the coupled position or state, the indicator bar and its integrated illuminator provides a visible line of readily observable light across the opening of the channel and directed away from the kingpin, which indicates successful coupling of the truck and trailer.

What is claimed:

1. A fifth wheel coupling indicator comprising:
a plate including a channel for receiving a kingpin of a trailer;
a coupling area proximate an end of the channel, wherein the kingpin is secured to the plate; and
an indicator bar including an illuminator integral therein, the indicator bar responsive to the coupling area, whereupon successful securement of the kingpin with the plate, the indicator bar is positioned into and/or across the channel with the illuminator lit.

2. The fifth wheel coupling indicator of claim 1, further comprising a cleaning implement positioned proximate the indicator bar, whereupon movement of the indicator bar, the illuminator contacts the cleaning implement.

3. The fifth wheel coupling indicator of claim 2, wherein the cleaning implement includes bristles.

4. The fifth wheel coupling indicator of claim 1, wherein the illuminator includes a light emitting diode, a metal filament, or a light bulb.

5. The fifth wheel coupling indicator of claim 1, further comprising;
a housing for housing the indicator bar when the indicator bar is not positioned across the channel.

6. The fifth wheel coupling indicator of claim 5, further comprising a cleaning implement attached to the housing and positioned proximate the indicator bar, whereupon movement of the indicator bar, the illuminator contacts the cleaning implement.

7. The fifth wheel coupling indicator of claim 6, wherein the cleaning implement includes bristles.

8. The fifth wheel coupling indicator of claim 7, wherein the illuminator includes a light emitting diode, a metal filament, or a light bulb.

9. A fifth wheel coupling indicator comprising:
a plate including a means for receiving a kingpin of a trailer;
a means for coupling the plate with the kingpin; and,
an indicator bar including a means for indicating coupling of the kingpin coupled with the plate, the indicator bar responsive to the means for coupling the plate with the kingpin, whereupon successful coupling of the kingpin with the plate, the indicator bar positioned across the means for receiving the kingpin and the means for indicating lit.

10. The fifth wheel coupling indicator of claim 9, further comprising:
a means for cleaning the means for indicating the kingpin coupled with the plate, the means for cleaning positioned proximate the indicator bar, whereupon movement of the indicator bar, the means for indicating contacts the means for cleaning.

11. The fifth wheel coupling indicator of claim 11, wherein the means for cleaning includes bristles.

12. The fifth wheel coupling indicator of claim 9, wherein the means for receiving the kingpin includes a channel, slot, or throat defined within the plate.

13. The fifth wheel coupling indicator of claim 9, wherein the means for indicating includes a light emitting diode, a metal filament, or a light bulb.

14. An indicator bar for facilitating coupling of a trailer to a transportation vehicle, the indicator bar comprising:
an illuminator integral within an indicator bar, whereupon successful coupling of the transportation vehicle and trailer, the indicator bar positioned proximate a coupling area with the illuminator lit.
